(19) United States
(12) Patent Application Publication
(10) Pub. No.: US 2012/0206925 A1
(43) Pub. Date: Aug. 16, 2012

(54) Collapsible Lampshade Kit

(75) Inventors: Michael Shenk, Freedom, CA (US); Joseph Boron, Oxford, NC (US)

(73) Assignee: Seascape Lamps Inc., Freedom, CA (US)

(21) Appl. No.: 13/025,131

(22) Filed: Feb. 10, 2011

(51) Int. Cl. F21V 1/06; F21V 1/00

(52) U.S. Cl. 362/352; 362/351; 362/355; 362/356

(57) ABSTRACT

A lampshade structure is fabricated from a collapsible, semi-flexible sheet material onto which pre-fastened magnetic strips are attached. One or more collapsible spring steel strip hoop(s) is magnetically adhered to the magnetic strips to thereby create a semi-rigid tubular structure. As part of a kit in the collapsed configuration, each spring steel strip hoop is folded upon itself and the flexible sheet material with a pre-fastened magnetic strip is rolled into a small diameter. In the expanded configuration, the spring steel strip hoop(s) is unfolded and expanded, whereupon the sheet material with pre-fastened magnetic strip is wrapped around the circumference of the spring steel strip hoop(s) relying solely on magnetic attraction as a fastening system in creating a semi-rigid hollow structure. This resultant collapsed assembly is 1/9th the volume of the fully expanded structure, thereby saving considerable shipping costs, both in the labor required for packaging materials and actual transportation costs. Furthermore, insofar as the components of the lamps shade are pliable, the risk of deformation of the packaged lampshade is greatly diminished even if the container is damaged in the shipping process. As well a container 1/9 the volume of a full size container has proportionately greater strength and is less apt to suffer shipping damage.

### FIELD OF THE INVENTION

The present invention generally relates to an improved lampshade construction and, more particularly, to a collapsible lampshade kit for fabricating a lampshade from a plurality of ready-to-assembly parts without special tools wherein the parts can be stored or shipped in a compact or collapsed condition.

### BACKGROUND OF THE INVENTION

Structurally rigid cylindrical lampshades (or display structures) incur higher shipping and storage costs due to their large volume and inability to “nest” in the manner of conical type lampshades. Structurally rigid cylindrical lampshade structures require shipping containers equal to at least the volume of a fully assembled single lampshade structure itself. Typically, shipping containers are created with additional volume so as to absorb possible intrusion into the container without damaging or deforming the lampshade structure itself, which is a naturally lightweight and delicate structure. In addition to the greater material and warehousing costs in shipping, a significant amount of labor is involved with assembling large containers and securing the lampshade structure in the container cavity with packing material.

Additionally, retail stores and distributors incur extra cost in the space requirement necessary in stocking cylindrical lamp shades compared to nesting, conical type lampshades. The manufacture of conventional rigid cylindrical lampshades requires mechanically fastening sheet material to one or more rigid hoops by applying adhesive or other mechanical means before the product is complete and saleable.

Currently available collapsible tubular structures in use for displays and lampshades employ rigid infrastructures that require mechanical fastening to the flexible sheet material that forms the diffuser. In some products, the rigid infrastructures used in existing collapsible tubular structures are segmented and disassemblable, thereby requiring reassembly by the end user. Reassembly, heretofore requires manipulating multiple parts in constructing the infrastructure and followed by the mechanical fastening of the infrastructure to the flexible sheet material.

Other collapsible tubular structures dispense altogether with a supportive infrastructure and, instead, rely solely on the structure of the flexible sheet material. These types of tubular structures, however, are limited to small diameters or rely on necessarily thicker flexible sheet material to compensate for the lack of supporting infrastructure. Thicker sheet materials have an increased opacity and generally preclude its use as a light-diffusing lampshade.

### SUMMARY OF THE INVENTION

The present invention is directed to a lampshade system containing collapsible parts that can be readily assembled into a tubular diffuser structure such as a lampshade. The invention is based in part on the development of a kit that includes a collapsible, semi-flexible sheet of material with pre-fastened magnetic strip that is adapted to magnetically adhered to one or more collapsible spring steel strip hoop(s). Upon to being secured to the hoop(s), the sheet of material forms the cover of a semi-rigid tubular structure such as a lampshade. Currently available collapsible tubular structures in use for displays and lampshades that employ support structure that is analogous to the skeletal infrastructure of the collapsible spring steel hoops used in conjunction with magnetic attachment of the present invention.

In one aspect, the invention is directed to a lampshade that includes:

a support hoop; and

a lamp cover made of a flexible material that forms a continuous, open-ended configuration having an edge that is secured to the support hoop by magnetic means.

In another aspect, the invention, the a lampshade that includes:

an upper support hoop;

a lower support hoop;

a lamp cover formed of flexible material and having a tubular-shaped structure with upper and lower perimeters, wherein the upper perimeter is secured to the upper support hoop by first magnetic means and the lower perimeter is secured to the lower support hoop by second magnetic means, such as a magnetic strip that is affixed to the lower perimeter, wherein the lamp cover is self-supporting; and

a mounting hub connected to the upper support hoop by a plurality of support members.

In a further aspect, the invention is directed to a kit for forming a collapsible lampshade that includes:

a lamp cover formed of a sufficiently rigid material that is stable on a longitudinal axis and has an expanded configuration in the form of a continuous, open-ended structure having an edge; and

a support hoop that is formed of a collapsible metal strip wherein the support hoop is dimensioned to be secured to the edge of the lamp cover by magnetic means.

The collapsible lampshade structure employs of a flexible spring metal strip hoop in conjunction with magnetic strips that are pre-fastened to the flexible sheet material as the means of both reducing shipping volume and providing a simple method of assembly for the end-user. In a preferred embodiment, the magnetic attraction by the pre-fastened magnetic strips is the sole means of fastening the shade to the support hoop and the diffuser structure in creating a semi-rigid hollow structure. Indeed, no longitudinally extending support member(s) connecting the upper and lower support hoops are required to maintain the lamp covers as self-supporting.

### BRIEF DESCRIPTION OF THE DRAWINGS

FIGS. 1 and 2 show the lampshade system in disassembled expanded and collapsed configurations, respectively;

FIGS. 3 and 4 show the components of the kit in pre-assembled forms; and

FIGS. 5 and 6 show the assembled lampshade.

### DETAILED DESCRIPTION OF PREFERRED EMBODIMENTS

The components of the lampshade kit 2 in an expanded or unfolded configuration with the pre-assembled parts as shown in FIG. 1 includes a lamp cover shade 4, diffuser 10, a socket collar 40, a plurality of spokes 20, and a support hoop 30. Lampshade 4 is formed from any suitable semi-flexible material, such as hard plastic, paper or the like. Preferably, shade 4 is formed of a single sheet of relatively rigid material having two longitudinally extending sides 52, 54 that can be secured to each other. Lampshade 4 has an upper edge which defines an upper periphery to which a magnetic strip 8 is attached and a lower edge which defines a lower periphery to which a magnetic strip 6 is attached. The magnetic strips are attached to the inner circumference of lampshade 4. The flexible magnetic strips are preferably adhesive backed and are attached along the inner perimeter along the upper and lower edges of lampshade 4.

Diffuser 10, which defines an aperture in the middle, is preferably made of a stretch fabric on the exterior that is supported by an internal inner spring steel support loop 12 and an internal outer spring steel support loop 14. Each of the inner and outer support loops is preferably constructed of sufficiently flexible material so that the diffuser is collapsible. The metal socket collar 40 has four threaded female holes that accommodate four corresponding machine thread on the proximal ends of spokes 20. Finally, spring steel support hoop 30 includes four sleeves 32 sized to accommodate the distal ends of spokes 20. The support loop is also fabricated of sufficiently flexible so as to be collapsible. As is apparent, both the internal outer spring support loop 14 of diffuser 10 and the support hoop 30 is made of a ferromagnetic material in order to engage the magnetic strips, which are commercially available from Adams Magnetic Products Co. (Irvine Calif.).

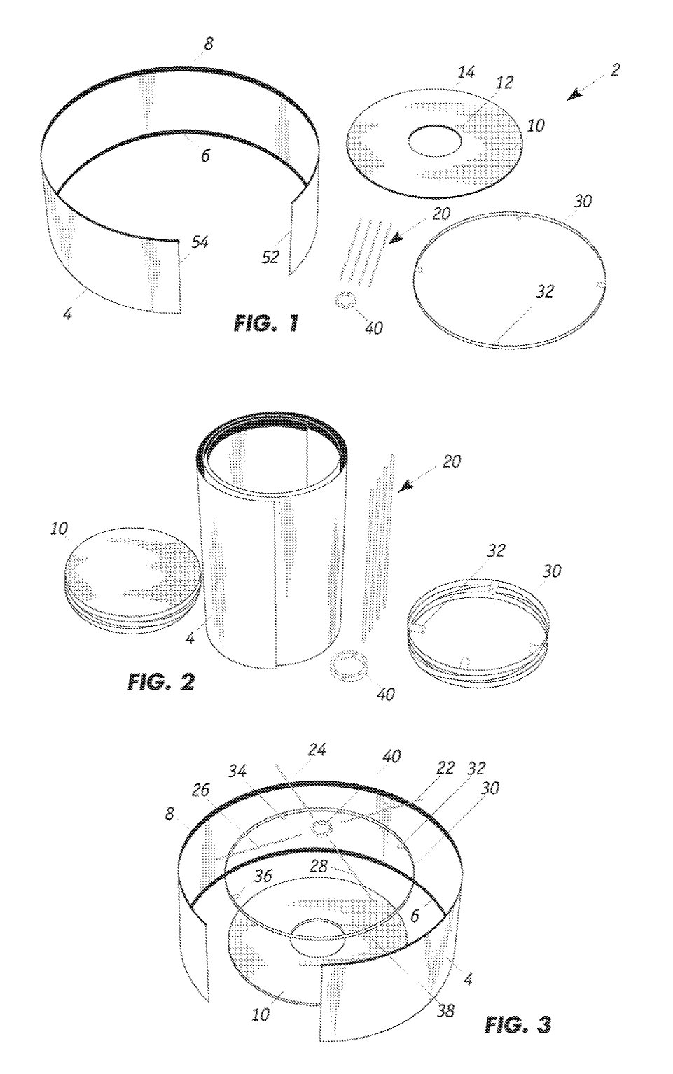

FIG. 2 shows the system in a collapsed configuration with the diffuser 10, lampshade 4 and support loop 30 in folded conditions. Specifically, spring steel strip hoop 30 is folded upon itself. The spring steel hoop, by way of a twisting motion, is folded upon itself thereby reducing the overall diameter of the hoop by two-thirds or more. The flexible sheet material of lampshade 40, with the pre-fastened magnetic strips, when rolled into its collapsed or rolled-up configuration as shown in FIG. 2 has a diameter that is considerably less than that of the expanded resultant lampshade 60 shown in FIG. 5. The collapsed assembly of component shown in FIG. 2 can be packaged for storage and/or shipment in a container that is only 1/9^{th} or less of the volume of the fully expanded structure 60 of FIG. 5, thereby saving considerable shipping costs, both in the labor required for packaging materials and actual transportation costs. Furthermore, since the components of the lampshade are pliable, the risk of deformation of the packaged lampshade is greatly diminished even if the container is damaged in the shipping process. Moreover, a container 1/9 the volume of a full size container has proportionately greater strength and is less apt to suffer shipping damage.

In assembling the lampshade from the kit, the end-user has merely to expand the spring steel hoop(s) by an un-twisting motion and wrap the flexible sheet 4 material with pre-fastened magnetic strips 6, 8 around the circumference of the upper and lower inner surface of hoop 30. No tools or fasteners are necessary to complete the assembly. As shown in FIG. 3, in mounting hub/spoke assembly the proximal ends of spokes 22, 24, 26 and 28 are aligned to the four threaded holes of socket collar 40 and the distal ends of spokes 22, 24, 26 and 28 are aligned to sleeves 32, 34, 36 and 38, respectively, of support hoop 30. The outer diameter of support hoop 30 is preferably the same as that of diffuser 10.

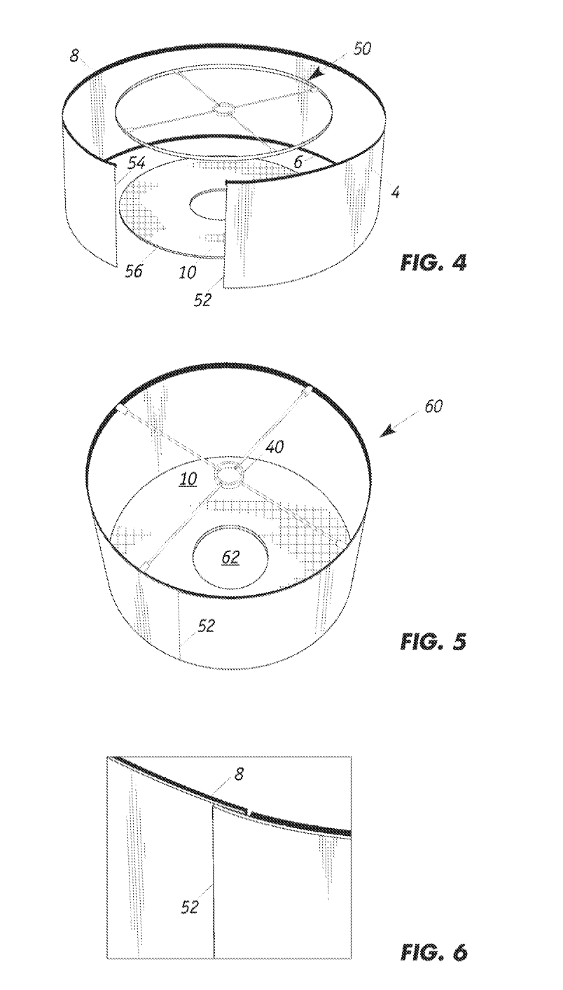

As shown in FIG. 4, once the hub/spoke assembly 50 is complete, final assembly takes place by securing the outer diameter of the assembly to magnetic strip 8 and securing outer perimeter 56 of diffuser 10 to magnetic strip 6. Sides 52 and 54 of lampshade 4 can be attached to each other with adhesive or hook and loop fasteners, which are available as VELCRO. Preferably, in the assembled, semi-rigid, hollow lampshade structure as shown in FIG. 5, the aperture 62 in diffuser 10 is aligned with socket collar 40 which serves as a mounting hub to which a light fixture (not shown) is secured. As shown in FIG. 6, a preferred technique of attaching the two sides of shade 4 is to fabricate side 52 with the end portions of upper and lower inner peripheries without the magnetic strip, so that side 52 can overlap side 54 while maintaining a smooth outer surface contour.

The foregoing has described the principles, preferred embodiments and modes of operation of the present invention. However, the invention should not be construed as being limited to the particular embodiments discussed. Thus, the above-described embodiments should be regarded as illustrative rather than restrictive, and it should be appreciated that variations may be made in those embodiments by workers skilled in the art without departing from the scope of the present invention as defined by the following claims.

What is claimed is:

1. A lampshade that comprises:
a support hoop; and
a lamp cover made of a flexible material that forms a continuous, open-ended configuration having an edge that is secured to the support hoop by magnetic means.

2. The lampshade of claim 1 wherein the lamp cover is made of a single sheet of relatively rigid material having two longitudinally-extending sides that are secured to each other and the lamp cover is self-supporting when its upper edge which defines a periphery that is secured to the support hoop.

3. The lampshade of claim 1 wherein the lamp cover has a substantially continuous circular shaped cross section.

4. The lampshade of claim 1 wherein the edge of the lamp cover has a strip of magnetic material attached thereto.

5. A lampshade of claim 1 comprising:
an upper support hoop; and
a lower support hoop, wherein the lamp cover has upper and lower edges, wherein the upper edge is secured to the upper support hoop by magnetic means and the lower edge is secured to the lower support hoop by magnetic means.

6. The lampshade of claim 5 wherein the lamp cover is made of a single sheet of relatively rigid material having two longitudinally-extending sides that are secured to each other and the lamp cover is self-supporting when its upper edge which defines an upper periphery is secured to the upper support hoop and its lower edge which defines a lower periphery is secured to the lower support hoop.

7. The lampshade of claim 5 further comprising a mounting hub that is connected to the upper support hoop by a series of spokes in radiating fashion.

8. The lampshade of claim 5 further comprising a diffuser that is secured to the lower support hoop.

9. The lampshade of claim 8 wherein the diffuser has an annular contour outer perimeter and has an aperture that defines an inner perimeter, wherein the outer perimeter is secured to the lower support hoop.

10. The lampshade of claim 5 wherein the upper and lower edges of the lamp cover each has a strip of magnetic material attached thereto.

11. The lampshade of claim 5 wherein no longitudinally extending support member connecting the upper and lower support hoops is required to maintain the lamp covers as self-supporting.

12. A lampshade that comprises:
an upper support hoop;
a lower support hoop;
a lamp cover formed of flexible material and having a tubular-shaped structure with upper and lower perimeters, wherein the upper perimeter is secured to the upper support hoop by first magnetic means and the lower perimeter is secured to the lower support hoop by second magnetic means, wherein the lamp cover is self-supporting; and
a mounting hub connected to the upper support hoop by a plurality of support members.

13. The lampshade of claim 12 further comprising a diffuser that is secured to the lower support hoop.

14. The lampshade of claim 12 wherein the diffuser has an annular contour outer perimeter and has an aperture that defines an inner perimeter, wherein the outer perimeter is secured to lower support hoop.

15. A kit for forming a collapsible lampshade that comprises:
a lamp cover formed of a sufficiently rigid material that is stable on a longitudinal axis and has an expanded configuration in the form of a continuous, open-ended structure having an edge; and
a support hoop that is formed of a collapsible metal strip wherein the support hoop is dimensioned to be secured to the edge of the lamp cover by magnetic means.

16. The kit of claim 15 wherein the collapsible metal strip that forms the support loop has a collapsed configuration wherein the metal strip is folded upon itself with a diameter that is approximately half that of the metal strip in its expanded configuration.

17. The kit of claim 15 wherein the lamp covers is made from plastic or paper.

18. The kit of claim 15 wherein the edge of the lamp cover has a strip of magnetic material attached thereto.

19. The kit of claim 15 wherein the lamp cover define upper and lower edges and the kit comprises:
an upper support hoop that is formed of a collapsible metal strip wherein the upper support hoop is dimensioned to be secured to the upper edge of the lamp cover by first magnetic means;
a lower support that is formed of a metal strip wherein the lower support hoop is dimensioned to be secured to the lower edge of the lamp cover by second magnetic means; and
a mounting hub that is configured to be connected to the upper support hoop by a series of spokes

20. The kit of claim 19 further comprising a diffuser that is secured to the lower support hoop.

21. The kit of claim 20 wherein the diffuser has an annular contour outer perimeter and has an aperture that defines an inner perimeter, wherein the outer perimeter is secured to lower support hoop.

22. The kit of claim 19 wherein the upper and lower edges of the lamp cover each has a strip of magnetic material attached thereto.
